(19) United States
(12) Patent Application Publication
(10) Pub. No.: US 2026/0035799 A1
(43) Pub. Date: Feb. 5, 2026

(54) Centrifugal Spray Additive Deposition

(71) Applicant: William Andrew Story, Southbridge, MA (US)

(72) Inventor: William Andrew Story, Southbridge, MA (US)

(73) Assignee: William Andrew Story, Southbridge, MA (US)

(21) Appl. No.: 19/275,263

(22) Filed: Jul. 21, 2025

Related U.S. Application Data
(60) Provisional application No. 63/678,527, filed on Aug. 1, 2024.

(51) Int. Cl. C23C 24/04; B28B 1/34; B29C 41/08; B29C 41/36; B29C 41/50

(52) U.S. Cl. CPC C23C 24/04; B28B 1/34; B29C 41/08; B29C 41/36; B29C 41/50

(57) ABSTRACT

A method and apparatus for consolidating granular feedstock material into a coating or bulk article is described. Typically, metal powder, either a pure metal or an alloy, is used as feedstock. However, mixtures of different metal powders may be used or mixtures of metal powders, metallic composite powders, and/or ceramic powders may be used as well. Feedstock material is injected into a rotating throwing wheel. The throwing wheel imparts kinetic energy to the feedstock material, accelerating individual feedstock particles to high velocities. The granular feedstock material is ejected from the throwing wheel by centrifugal forces at high velocities. When the particles impact a suitable surface with sufficient velocity, the feedstock powders will deposit and bond to the surface rather than rebounding or merely embedding, producing a deposition. By relative translation between the surface and the wheel, a coating or article is fabricated.

### CROSS-REFERENCE TO RELATED APPLICATIONS

This application claims the benefit of provisional patent application Ser. No. 63/678,527 filed 2024 Aug. 1 by the present inventor.

### STATEMENT REGARDING FEDERALLY SPONSORED RESEARCH OR DEVELOPMENT

This invention was developed without funding or support from the U. S. federal government.

### BACKGROUND OF THE INVENTION

### 1. Technical Field

This invention relates generally to metal plating and metal additive manufacturing processes, and more specifically to spray processing of granular feedstock material to produce metallic or metallic composite coatings or bulk articles.

### 2. Prior Art

The following is a tabulation of some prior art that presently appears relevant:

U. S. Patents

| Patent Nr. | Kind Code | Issue Date | Patentee |
|---|---|---|---|
| 0108408 | A | 1870 Oct. 18 | Tilghman |
| 0554473 | A | 1896 Feb. 11 | Beeg |
| 0706701 | A | 1902 Aug. 12 | Thurston |
| 2263321 | A | 1941 Nov. 18 | Unger |
| 3491563 | A | 1970 Jan. 27 | Alonso |
| 4566230 | A | 1986 Jan. 28 | Carpenter |
| 5302313 | A | 1994 Apr. 12 | Alkhimov et al. |
| 6623796 | B1 | 2003 Sep. 23 | Van Steenkiste |
| 6598441 | B1 | 2003 Jul. 29 | Cavaliere et al. |
| 6797411 | B2 | 2004 Sep. 28 | Sodani et al. |
| 6808817 | B2 | 2004 Oct. 26 | Morelli et al. |
| 8268237 | B2 | 2012 Sep. 18 | Calla et al. |
| 11185921 | B2 | 2021 Nov. 30 | Hoffman et al. |

U.S. Patent Application Publications

| Publication Nr. | Kind Code | Publ. Date | Applicant |
|---|---|---|---|
| 202110402482 | A1 | 2021 Dec. 30 | Ferguson et al. |

Foreign Patent Documents

| Foreign Doc. Nr. | Country Code | Kind Code | Pub. Dt. | App. or Patentee |
|---|---|---|---|---|
| 101372065 | CN | B | 2010 Nov. 10 | [symbol] et al. |
| 2015532893 | JP | B2 | 2015 Nov. 16 | [symbol] |
| | | | | [symbol] et al. |
| 2023202239 | AU | B2 | 2025 Jan. 2 | Horst et. al. |

### Non-Patent Literature Documents

R. M. Leliaert et al., “Abrasive Blast Cleaning”, Metals Handbook Ninth Edition, Volume 5: Surface Cleaning, Finishing, and Coating., American Society for Metals, 1982, p. 86.
H. J. Plaster. Blasting Cleaning and Allied Processes, Vol. 2., Industrial Newspapers Limited, 1973, pp. 151-152.
I. Botef and J. Villafuerte. “Overview”, Modern Cold Spray: Materials, Process, and Applications, Springer International, 2015: p. 1.
M. Jones. et al., “Solid-state manufacturing of tungsten deposits onto molybdenum substrates with supersonic laser deposition,” Materials Letters, Volume 134 (2014) pp. 295-297.
W. A. Story. “Chapter 1: Introduction to the Cold Spray Process,” Processing-Microstructure- Property Relations in High Pressure Cold Spray Deposition of AA2024 and AA7075. Doctoral dissertation, University of Alabama Libraries, 2018, pp. 1-4.
W. A. Story et al, “Laser assisted cold spray of Fe—Ni—Zr oxide dispersion strengthened steel” Materialia Volume 3, pp. 239-242 (2018).
I. Botef, and J. Villafuerte. “Characteristics of Feedstock Materials”, Modern Cold Spray: Materials, Process, and Applications, Springer International, 2015: pp. 84-86.
W. A. Story. “Chapter 4: Residual Stress in Cold Spray,” Processing-Microstructure-Property Relations in High Pressure Cold Spray Deposition of AA2024 and AA7075. Doctoral dissertation, University of Alabama Libraries, 2018, pp. 97-98.
O. C. Ozdemir et al, “Predicting the effects of Powder Feeding Rates on Particle Impact Conditions and Cold Spray Deposited Coatings,” Journal of Thermal Spray Technology Volume 26, pp. 1598-1615 (2017).

### 3. Summary of Prior Art

The prior art for this invention relates to two different fields. First, the art relates to centrifugal blasting machines and their use for surface modification of metal components. Second, the art relates to gas dynamic cold spray (or “cold spray”), in which feedstock material is accelerated to supersonic speeds by means of a heated and pressurized gas. Upon impact with a surface, deposition occurs by means of mechanical deformation rather than melting. This process is used to produce coatings or freestanding articles if the deposited material is removed from the target surface after deposition.

### 4. Prior Art Relating to Centrifugal Blasting Machines

Grit blasting was first patented in 1870 using a pressurized fluid to accelerate abrasive media towards a target surface for cleaning of the surface. Shortly thereafter, the first patent for the first centrifugal blasting machine was patented in 1896. Centrifugal blast machines are commonly used for cleaning, shot peening, and surface modification of metallic surfaces. Metal shot, typically steel shot, is injected into a rotating wheel. Vanes in the wheel transfer kinetic energy to the shot, accelerating shot by centrifugal forces. By directing the shot ejected from the wheel in a controllable fashion, a target surface may be abraded by the shot.

Centrifugal blasting is used where large volumes of parts must be processed. Up to 80,000 pounds per hour of shot may be fed by a single machine with a 100-horsepower motor (see R. Leliaert et al. “Abrasive Blast Cleaning,” Metals Handbook Ninth Edition, Volume 5: Surface Cleaning, Finishing, and Coating.) Media is accelerated at speeds up to 122 meters per second, but typically 75 meters per second is used. In high-volume applications, centrifugal blasting is preferred to fluid-based blasting. In fluid-based blasting, particles are accelerated to blasting speed by drag forces due to the differences in velocity between the fluid and injected feedstock particles. This is much less efficient than directly transferring energy by impact with a rotating wheel. The energy required to accelerate the same mass of feedstock material to a given velocity is typically 20 times more with a pneumatic system running off an air compressor than a centrifugal blast system (see H. Plaster, Blast Cleaning and Allied Processes, Vol 2.) For this reason, centrifugal blast systems are preferred to fluid-based blast systems when large volumes of metal must be processed.

Several patents describe using a centrifugal blasting method for embedding zinc particles on a metallic surface as a lubricant for extrusion or forging processes, but these coatings have an average thickness of less than 5 micrometers. However, there have been no reports of using centrifugal blasting to produce metallic coatings with an average thickness greater than 5 micrometers.

A summary of relevant shot peening and centrifugal blasting patents is provided below.

Tilghman in U.S. Pat. No. 108,408 (1870) shows use of fluid directed through a nozzle to propel abrasive media for cleaning of various surfaces.

Beeg in U.S. Pat. No. 554,473 (1896) shows use of a rotating wheel to throw abrasive material at metal castings to clean the surfaces of the castings.

Unger in U.S. Pat. No. 2,263,321 (1941) shows a design of centrifugal blasting unit which may be manipulated by an operator for cleaning of castings.

Alonso in U.S. Pat. No. 3,491,563 (1970) shows use of a centrifugal blasting unit to accelerate metal shot to shot peen metal surfaces. While some metal shot may remain embedded, this would be undesirable as the primary advantage of the shot peen process is to impart surface compressive residual stresses to extend fatigue life.

Carpenter in U.S. Pat. No. 4,566,230 (1986) shows use of a centrifugal blasting unit for preparing the surface of aluminum for lithography by using a finer than typical abrasive media. The purpose of this surface preparation is to remove contaminants and reduce surface roughness. Embedding or deposition of abrasive media would be undesirable in this application.

Cavaliere et al. in U.S. Pat. No. 6,598,441 (2003) shows use of a centrifugal blasting process to deposit a zinc coating on steel to serve as a lubricant for subsequent deformation processing. This is achieved by using a mixture of zinc alloy powder and steel shot. Cavaliere speculates that maximum thickness of 300 milligrams per decimeter squared might be achieved by this process. Zinc has a density of 7.13 grams pers centimeter cubed (7,130,000 milligrams per decimeter cubed), corresponding to a maximum thickness of 4.2×10⁻⁶ meters (4.2 micrometers). Furthermore, deposition of no other metals besides zinc, zinc alloys, or mixtures thereof with iron-based short are claimed.

Sodani et al. in U.S. Pat. No. 6,797,411 (2004) shows use of a centrifugal blasting unit as a part of a process for producing galvanized steel, but the centrifugal blasting unit is used to modify the surface of the steel prior to hot-dipping in a bath of liquid zinc, rather than using blasting to deposit a layer of zinc.

[symbol] et al. in CN. Pat. No. 101,372,065 (2008) shows use of centrifugal wheel blasting for preparing the surfaces of steel and copper which are joined by explosion welding. However, the centrifugal wheel blasting process is only used to remove surface oxides that would interfere with bonding and to achieve a desired surface roughness; bonding is achieved by directed explosives.

[symbol] et al. in JP. Pat. No. 2015532893 (2012) shows use of centrifugal wheel blasting as a step for cleaning the surface of aluminum as a pre-treatment step for anodizing aluminum to produce a satin finish. However, the abrasive material is used to remove contaminants from the aluminum surface rather than to produce a coating, and the production of the anodized layer is carried out by subsequent electrochemical means.

Horst et al. in AU. Pat. 2023202239 (2025) shows use of centrifugal wheel blasting as part of a process for producing corrosion resistant coatings on fasteners. However, wheel blasting is only used to prepare the surface for coating, and the coating is achieved by thermal spray of feedstock material onto the fastener after surface preparation.

### 5. Prior Art Relating to Cold Spray

Cold spray in its modern embodiment was patented in 1994. In cold spray, granular feedstock materials are accelerated to high velocities in a manner similar to pneumatic grit blasting by transfer of kinetic energy from a high-velocity gas to entrained powder particles through drag forces. However, unlike conventional pneumatic grit blasting, much higher-pressure gases (up to 1000 pounds per square inch in cold spray versus typically 90 pounds per square inch in grit blasting) are used. Additionally, the gas is typically heated prior to the nozzle. As this heated gas flows through the nozzle, the gas will cool, expand, and accelerate. These higher temperatures and pressures allow much higher impact velocities to be achieved in cold spray compared to conventional pneumatic grit blasting. Particle impact velocities of 300 meters per second-1200 meters per second are common in cold spray (see I. Botef and J. Villafuerte. “Overview”, Modern (old Spray: Materials, Process, and Applications), whereas velocities in pneumatic grit blasting typically do not exceed 120 meters per second.

While one might expect the higher impact velocities in cold spray to result in a greater erosion rate of the surface subjected to the impacting of feedstock particles, with sufficiently high velocities metallic materials will deposit and produce a coating. These coatings are not merely the result of mechanical embedding, but metallurgical bonding between impacting particles and the underlying surface. For this reason, coatings with thicknesses greater than that of a single particle diameter may be produced with cold spray. Since inception, cold spray has been used for protective metal coatings of articles, additive repair of damaged components, and additive manufacturing of components.

The primary advantage of cold spray vis-a-vis similar thermal spay and other additive manufacturing processes is the formation of metallurgical bonding without the need for melting. This enables deposition of metals with high melting points such as refractory metals (see M. Jones et al. “Solid-state manufacturing of tungsten deposits onto molybdenum substrate with supersonic laser deposition,” Materials Letters); repair of components highly sensitive to heat affected zones such as 7000 series aluminum alloys (see W. Story. “Chapter 1: introduction to the cold spray process,” Processing-Microstructure-Property Relations in High Pressure Cold Spray Deposition of AA2024 and AA7075); and deposition of high-energy microstructures such as metal matrix composites, oxide dispersion strengthened alloys, and nanocrystalline metals (see W. Story, “Laser assisted cold spray of Fe—Ni—Zr oxide dispersion strengthened steel,” Materialia.) Despite these advantages, there are numerous limitations of the cold spray process that inhibit wider adoption.

In cold spray, particles deposited with a higher impact velocity will exhibit more desirable properties than particle deposited with lower impact velocity, such as higher tensile strength and higher deposition efficiency. In many cold spray applications or potential applications, the effectiveness of the application is limited by lower-than-optimal particle impact velocity. The most important parameters which may be used to control particle impact velocity of a given material are nozzle geometry, gas pressure, gas temperature, and carrier gas species.

There has been much work done in optimization of internal nozzle geometry for cold spray, and there are few gains left to be had here for advancing the state of the art in cold spray.

Despite the claims of Van Steenkiste et al. in U.S. Pat. No. 6,623,796 (2003) of using particles with diameter up to 250 micrometers, it remains common in the industry to use particles with a smaller particle size distribution, typically 5 micrometers-50 micrometers (see I. Botef and J. Villafuerte, “Characteristics of feedstock materials,” Modern Cold Spray: Materials, Process, and Applications). Larger particles are not fully accelerated in the brief time they are inside the plume of gas. On the other hand, smaller particles with less inertia are fully accelerated in the plume, but are subsequently decelerated by bow shock wave generated when the supersonic gas stream impinges on a surface. Furthermore, fine particles often cause fouling of the cold spray nozzle. Finer metal powders are typically more difficult to produce than coarser metal powders, and the high sensitivity of the cold spray process on particle diameter increases the cost of feedstock material.

Increasing the temperature of the heated gas in cold spray increases the speed of sound of the carrier gas. This will increase the velocity of entrained powder particles. There are several challenges with this approach however. The increase in particle velocity associated with an increase in temperature is not linear, but rather gives diminishing returns. With increasing temperature, the associated cold spray equipment becomes much more difficult to manufacture as pressure-bearing components and heating elements must withstand higher temperatures. Excessive carrier gas temperature in cold spray can cause melting of feedstock materials and thermal damage to either the substrate or deposition. This heat input eliminates the advantages cold spray has over traditional thermal spray.

This thermal damage be due to alteration of the microstructure or nanostructure of the deposited material or substrate. A heat affected zone will be injurious to almost any engineering alloy, but several examples are given here. Heat input may cause undesirable softening of a precipitation strengthened aluminum due to coarsening of nano-scale precipitates. Another example of is undesired softening in steel caused by conversion of martensite to ferrite. Austenitic stainless steels may be sensitized by precipitation of undesirable carbides, resulting in accelerated corrosion. At sufficiently high temperatures the surface of the deposited material may react with oxygen, nitrogen, and hydrogen in the air, causing undesirable effects in the deposited material.

This heat input may also result in undesirable residual stresses in cold spray depositions. While the peening effect of impacting particles will result in generally desirable surface compressive residual stresses from a fatigue standpoint, the thermal stresses may result in undesirable tensile residual stresses. Furthermore, residual stresses may result in distortion of the component being deposited onto, or in severe cases cracking or delamination of the deposited material (see W. Story, “Chapter 4: residual stress in cold spray,” Processing-Microstructure-Property Relations in High Pressure Cold Spray Deposition of AA2024 and AA7075.)

For all of the above practical and metallurgical reasons, it is desirable to cold spray at a lower temperature without sacrificing velocity.

Particle velocity may also be increased by increasing gas pressure. However, there are several challenges with this approach. Pressure ratings of cold spray equipment and the available gas source pressure limits the maximum pressure which may be used for spraying. As with increasing temperature, increasing pressure gives diminishing returns in increasing particle impact velocity. However, the total gas consumption rate and therefore total gas cost of the process will be directly proportional to the spray pressure. Finally, because of the increased flow with increased pressure, the heat input at a higher-pressure condition will be greater than the heat input of a lower pressure condition at the same temperature. For these reasons, even were new cold spray equipment designed with higher pressure capabilities, this would do little to meaningfully advance the state of the art.

To produce high-quality cold spray depositions without excessive heat input, helium is often used as a carrier gas. Helium has a higher speed of sound than the more commonly used nitrogen or compressed air. However, helium is much more expensive than nitrogen and air and is a non-renewable resource. This makes cold spray with helium cost prohibitive for most cold spray applications.

Hydrogen has a higher speed of sound than helium, and cold spray with hydrogen is a possible approach to achieving high quality depositions without excessive gas costs. However, there are numerous challenges with this approach. Hydrogen is flammable in air in volumetric concentrations of 5%-75%. Spraying large volumes of hydrogen in an enclosed environment presents an enormous risk to equipment and operator from explosion. Furthermore, hydrogen easily diffuses in many metals, causing embrittlement of the metal, which has further implications for both safety and deposited material. This poses an additional safety risk as high-pressure components of the cold spray system may become embrittled. Even without flammable gas, brittle failures of high-pressure components are extremely dangerous. Furthermore, such a failure could result in a high-pressure gas leak defeating containment methods. Finally, if this hydrogen is absorbed in the feedstock material, this may make the material too brittle and hard to effectively deposit, and any deposit produced with this material will be brittle.

This combination of limited gas selection and maximum temperature and pressure at which cold spray may be operated often limits maximum particle impact velocity. As a result, the properties for many current cold spray applications are sub-optimal. Furthermore, many potential applications for cold spray are impracticable due to insufficient particle velocity.

Finally, the cold spray process is limited by low deposition rates. Deposition rates in cold spray are typically limited to 10-30 grams per minute (2-4 pounds per hour) (see O. Ozdemir et al. “Prediction the effects of powder feeding rates on particle impact conditions and cold spray deposited coatings,” Journal of Thermal Spray Technology.) There are several factors inherently limiting the deposition rates with cold spray. Higher feedstock deposition rates will remove more energy from the supersonic gas flow, reducing impact velocity. Thus, to feed a higher volume of material, higher gas flow rates are needed. This will increase both the gas consumption of the process and the energy consumption as more power will be needed to heat a higher flow rate of gas to the same temperature. In addition to increasing the cost of the process, this will result in greater heat input into the part, which is undesirable for reasons previously discussed. For these reasons, cold spray is uneconomical for many high-volume production applications.

Many potential cold spray applications are presently unviable for technical and economic reasons. The ability to deposit material in a manner similar to cold spray with higher particle impact velocities, without excessive cost or heat input, and at a much higher deposition rate would enable many of these applications.

A summary of relevant cold spray patents and prior art is provided below.

Thurston, in U.S. Pat. No. 706,701 (1902) shows a process for using compressed air to deposit metal particles on a metal surface. It should be noted that in this case particles are mechanically embedded in a surface, rather than metallurgically bonded.

Alkhimov et al. in U.S. Pat. No. 5,302,414 (1994) shows a process of using heated, pressurized gas with a converging-diverging (De Laval) nozzle to produce a metallic coating from metal feedstock material 1 micrometer-50 micrometers in diameter. Bonding of metal powder to the substrate is achieved by mechanical deformation of feedstock material upon impact with a substrate, rather than fusion of a molten particle to a substrate. This process describes foundation of modern cold spray.

Van Steenkiste in U.S. Pat. No. 6,623,796 (2003) shows improvements in cold spray process allowing for spraying of larger particles with an average particle diameter of 106 μm up to 250 μm.

Morelli et al. in U.S. Pat. No. 6,808,817 (2004) shows use of cold spray for producing a metal matrix composite consisting of a primary metallic matrix phase and a secondary ceramic inclusion phase.

Calla et al. in U.S. Pat. No. 8,268,237 (2012) shows use of cold spray for depositing nanocrystalline metal coatings.

Hofmann et al. in U.S. Pat. No. 11,185,921 (2021) shows a process for consolidation of an amorphous metal without recrystallization by several additive manufacturing processes, including cold spray.

Ferguson et al. in U.S. patent application Ser. No. 17/344,204 shows a process in which cold spray is used to produce a coating on a mandrel. The coating is subsequently removed from the mandrel by mechanical means to produce a freestanding part.

### BRIEF SUMMARY OF THE INVENTION

An invention is disclosed herein for a method and apparatus for depositing metallic materials and metallic composite materials (“centrifugal spray additive”). This is accomplished by injecting granular feedstock material into a rotating throwing wheel. Kinetic energy is transferred from the throwing wheel to the granular feedstock material, accelerating the feedstock to high speeds. The feedstock is subsequently ejected from the throwing wheel, and with sufficient impact velocity with a suitable target surface a combination of metallurgical bonding and mechanical interlocking can create a thick deposition. Manipulation of the target surface and throwing wheel relative to each other allows coatings or articles to be produced by this process.

This process is suitable for granular feedstock of pure metals, metallic alloys, or mixture thereof. In addition to pure metals and metallic alloys, ceramics or cermet material may be fed along with metallic feedstock to produce metallic composite coatings.

This process is especially suitable for nano-structured materials which are more readily produced in granular form than bulk, consolidated form. Especially noteworthy nano-structured materials include dispersion strengthened alloys, amorphous metals, nano-crystalline metals, carbon nanotube reinforced metals, nano-diamond reinforced metals, and graphene reinforced metals.

In addition to metallic materials, polymer-based materials may be deposited by centrifugal spray additive.

By producing relative motion between the throwing wheel and target surface, uniform coatings can be produced on a desired surface or component. Additionally, freestanding deposits may also be produced by depositing onto a reusable or sacrificial surface and removing the deposit afterwards by chemical, mechanical, or thermal means afterwards.

The centrifugal spray additive process is suitable for granular feedstock material with a wide range of particle sizes. Feedstock with particulate diameter or equivalent particulate diameter of approximately 50 micrometers to 1000 micrometers are of the greatest interest to centrifugal spray additive.

While this process can be carried out under standard atmospheric conditions, for certain materials and applications it may be desirable to carry this process out in a controlled atmosphere or a vacuum to avoid undesirable chemical reactions or alter the drag characteristics of the ejected feedstock material.

Several novel hardware elements may necessary to spin the rotating wheel at speeds sufficient to accelerate particles to the required velocity for deposition. A steady rest to support a throwing wheel seated on an axel may also be necessary for even rotation. Finally, one or more of the rollers of this steady rest may be actuated by a piston or spring to ensure constant force is applied by the steady rest.

It is possible to directly drive the throwing wheel with a motor with sufficiently high rotational speed and torque. However, it may be desirable to indirectly drive the throwing wheel, for example using drive belts or a transmission to prolong motor bearing life. By this indirect drive mechanism, the rotational speed of the throwing wheel may be increased relative to the motor.

The throwing wheel may also be indirectly driven by a drive roller. A drive roller is brought in contact with an axel on which the throwing wheel is seated. The drive roller has a greater diameter than that of the throwing wheel axel, such that the rotational speed of the throwing wheel is greater than that of the drive roller.

### Advantages

In centrifugal blast cleaning, a rotational speed of 2250 rotations per minute is most commonly used. The rotational speed, together with the diameter of the throwing wheel and to some extent the shape and design of the wheel vanes will determine the speed of the ejected particles, and speeds of 15-122 meters per second are typical. Given the speeds typical of the standard centrifugal blasting operation, one would not expect buildup of material with a metallic feedstock. However, by increasing particle ejection velocity to greater than 300 meters per second through modification of throwing wheel geometry and modification of the system such that much higher particle velocities are attained, deposition of material is possible.

Just as centrifugal grit blasting and shot peening provides advantages in many situations over fluid-accelerated grit blasting and shot peening, the Centrifugal Spay Additive process provides advantages over cold spray process in many situations. Accelerating feedstock particles by drag forces as is necessary with fluid-based acceleration is energy inefficient compared to accelerating feedstock material directly by spinning component; approximately 20 times as much energy must be used to accelerate abrasive blasting grit with air rather than using rotating wheel. This allows the centrifugal spray additive process to be scaled to larger volume applications than traditional cold spray processes. Powder feed rates in cold spray are relatively low, typically 2 pounds per hour to 4 pounds per hour, whereas feed rates up to 80,000 pounds per hour are used with centrifugal blasting equipment.

Unlike cold spray, the centrifugal spray additive process does not require large volumes of high-pressure gas or expensive gas compression equipment as cold spray. Furthermore, centrifugal spray additive does not require the use of heated gas as cold spray does. Because of this the undesirable effects of heat input on microstructure and residual stress evolution are avoided.

This low heat input makes centrifugal spray additive especially suitable for nano-structured materials. Many conventional consolidation methods for these nano-structured granular materials are economically unviable, produce materials with inferior properties, and/or cause coarsening of the nano-structure.

Furthermore, particle velocity in centrifugal spray additive is scaled more easily than in cold spray. Particle velocity is directly proportional to rotational speed and throwing wheel diameter, rather than diminishing as in cold spray. Furthermore, unlike increasing temperature and pressure in cold spray, changing rotational speed or wheel geometry does not cause secondary, undesirable effects in the deposited material or article being deposited onto.

The properties of metals deposited by kinetic means tend to improve as particle impact velocity. As previously discussed, in cold spray pressure, temperature, and carrier gas species limit the maximum achievable particle impact velocity in cold spray. High impact velocities can be achieved much more economically in centrifugal spray additive by avoiding the use of expensive helium or dangerous hydrogen.

In addition to the previously listed advantages over cold spray, the centrifugal spray additive process is less sensitive to feedstock size distribution. Despite the claims of Van Steenkiste et al. in U.S. Pat. No. 6,623,796 (2003), it remains common in the industry to use particles with a smaller particle size distribution, typically 5 micrometers-50 micrometers (see I. Botef and J. Villafuerte, “Characteristics of Feedstock Materials”, Modern Cold Spray: Materials, Process, and Applications.) Larger particles are not fully accelerated in the brief time they are inside the plume of gas. On the other hand, smaller particles are fully accelerated in the cold spray plume, but are subsequently decelerated by bow shock wave generated when the supersonic gas stream impinges on a surface. Furthermore, fine particles often cause fouling of the cold spray nozzle. In centrifugal spray additive, accelerated powder particles have a more uniform velocity profile across size distribution due to the absence of a bow shock wave. Feedstock for cold spray material can cost 10 times equivalent wrought or cast material on a per-weight basis due to the tight size requirements. By using coarser feedstock material with less stringent particle size requirements, the centrifugal spray additive process can significantly reduce these costs.

Centrifugal spray additive is suitable for large volume additive or coating applications. For example, a moving centrifugal spray additive unit may be used to coat a large surface area of an existing structure. Coatings may be used for improved resistance to mechanical wear, corrosion, high temperatures, fatigue, impact, and/or for aesthetic purposes.

Centrifugal spray additive may also be used for consolidating large billets of material where processes such as casting, forging, or machining may be impracticable and newer additive manufacturing processes such as cold spray, directed energy deposition, or laser powder bed fusion are prohibitively expensive or unsuitable.

Centrifugal spray additive is especially advantageous in cases where metal must be produced in powder form before consolidation into a bulk material. This includes materials such as refractory metals, titanium alloys, oxide dispersion strengthened alloys, nano-crystalline metals, metal-matrix composites, amorphous metals, and other nano-structured metals. Many of these materials are challenging to deposit commercially in cold spray, limited by insufficient particle impact velocities.

Finally, centrifugal spray additive may be used for near-net shape fabrication of components to significantly reduce machining costs, material wastes, and eliminate long lead times associated with procuring large billets of material.

### BRIEF DESCRIPTION OF THE DRAWINGS

FIG. 1. shows a flow chart of the centrifugal spray additive process.

FIG. 2. shows an exploded perspective view of a throwing wheel and hopper assembly of a centrifugal spray additive machine.

FIG. 3. shows a perspective view of a centrifugal spray additive machine.

FIG. 4. shows a perspective view of an alternative embodiment of a centrifugal spray additive machine.

FIG. 5. shows a perspective view of another alternative embodiment of a centrifugal spray additive machine.

### DETAILED DESCRIPTION OF THE INVENTION

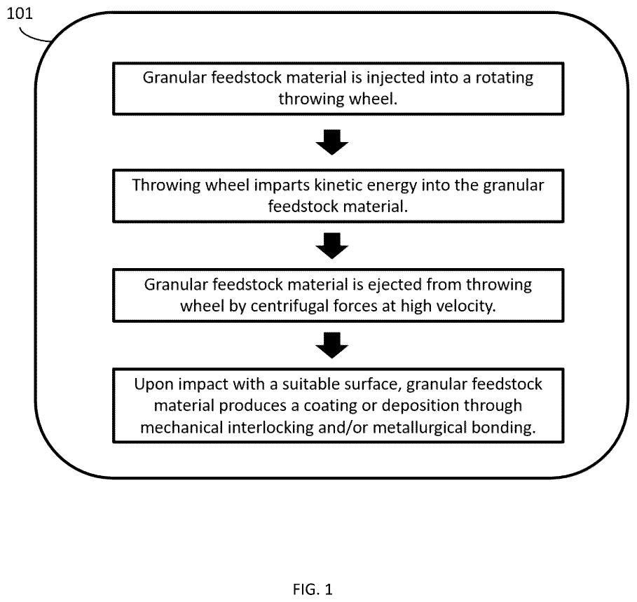

FIG. 1. shows a flow chart of the centrifugal spray additive process (101). Granular feedstock material is injected into a rotating throwing wheel. Energy is transferred from the throwing wheel to the granular feedstock material as individual particles come in contact with the throwing wheel. This energy accelerates the granular feedstock material to high velocities, and the feedstock material is ejected from the throwing wheel at high velocities by centrifugal forces. When this granular feedstock material traveling at high velocities impacts upon a suitable surface, with sufficiently high velocity a coating or deposition will be produced through mechanical interlocking and/or metallurgical bonding.

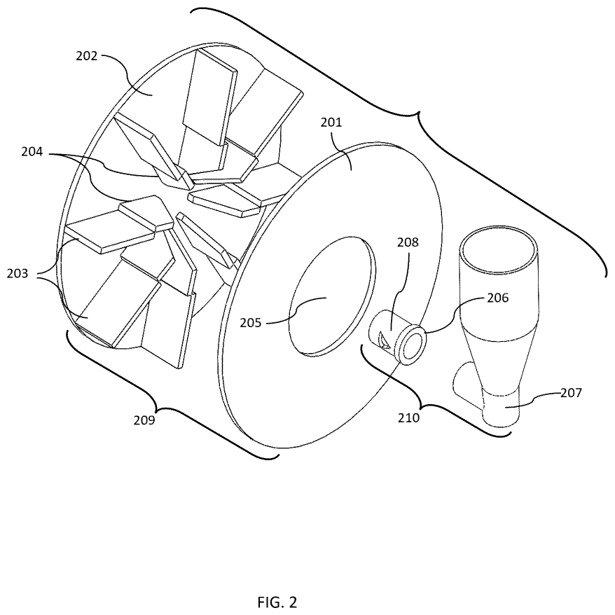

FIG. 2. shows an exploded perspective view of a throwing wheel and hopper assembly. A front disc (201) and back disc (202) have multiple protrusions (203) in a radial pattern connecting the two discs. In addition to the throwing wheel protrusions (203), impeller blades (204) are supported and connected to the front disc (201) and back disc (202). The front disc (201) has an opening (205) in the middle. A control cage (206) is inserted into the opening (205) in the front disc (201), but is not physically connected to the any of the aforementioned components, such that the control cage is stationary while the throwing wheel assembly rotates. Granular feedstock material from a hopper (207) is fed through a feed opening (208) in the control cage (206) into the impeller blades (204), which churns and flings granular feedstock material into the protrusions (203). Contact of the granular feedstock material with the rotating protrusions (203) accelerates feedstock particles by contact, ejecting the feedstock particles from the throwing wheel at high speeds. The throwing wheel (209) comprises (201, 202, 203, 204, 205) and the hopper assembly (210) comprises (206, 207, 208).

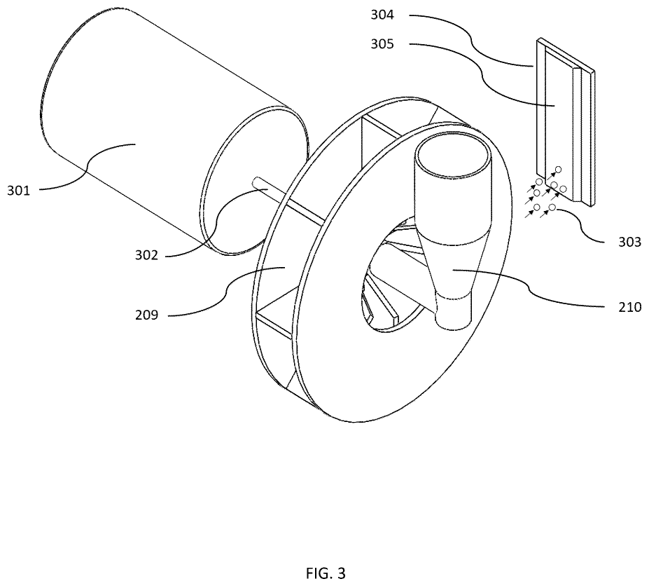

FIG. 3. shows a perspective view of a centrifugal spray additive machine. A motor (301) rotates an axel (302) which bears a throwing wheel (209). Granular feedstock material is injected into the throwing wheel (209) by a hopper assembly (210) and accelerated to high velocities as energy is transferred from the throwing wheel (209) to the granular feedstock material. Granular feedstock material is ejected at high velocities (303) by centrifugal forces towards a suitable article (304). With sufficiently high velocity, particles will plastically deform and produce a deposition (305) upon impact with the substrate through a combination of mechanical interlocking and/or metallurgical bonding. Particle scale exaggerated to show detail.

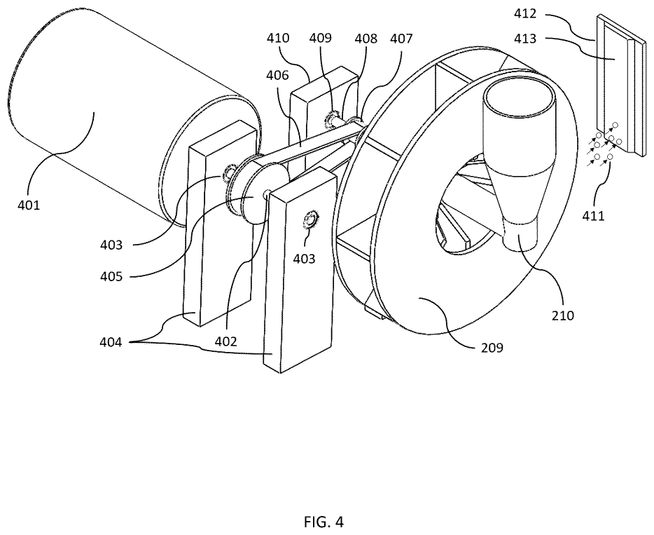

FIG. 4 shows a perspective view of an alternative embodiment of a centrifugal spray additive machine. A motor (401) drives an axel (402) supported by bearings (403) in bearing housings (404). On this axel (402), a drive pulley (405) is seated, which is coupled to a drive belt (406). This drive belt (406) is coupled to a second drive pulley (407) seated upon a second axel (408) supported by another bearing (409) and bearing housing (410). A throwing wheel (209) is attached to the second axel (408) and granular feedstock material are fed into the throwing wheel (209) by a hopper assembly (210). Granular feedstock material (411) is accelerated by and ejected from the throwing wheel at high speeds towards a suitable article (412), producing a deposition (413) upon impingement. Particle scale exaggerated to show detail.

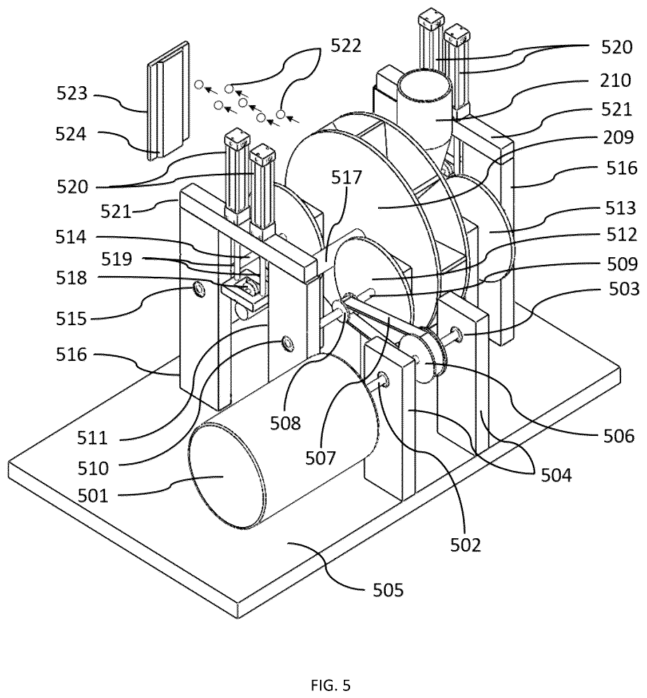

FIG. 5 shows a perspective view of another alternative embodiment of a centrifugal spray additive machine. A motor (501) rotates an axel (502) supported by bearings (503) in bearing housings (504). The bearing housings (504) are supported by a base plate (505). Seated on this axel (502) is a drive pulley (506), which is coupled to a drive belt (507). This drive belt (507) is connected to another drive pulley (508), which rotates a second axel (509), supported by additional bearings (510) in bearing housing (511). Attached to this second axel (509) is a drive roller (512). In addition to this drive roller (512), additional support rollers (513) equal in diameter to the drive roller (512) are supported by additional axels (514) and additional bearings (515) in bearing housings (516). The axels (514) of these support rollers (513) in this embodiment are not be coupled to the motor (501). Together the drive roller (512) and undriven support rollers (513) support a throwing wheel axel (517), on which the throwing wheel (209) is seated. This throwing wheel axel (517) is driven through contact with the aforementioned drive roller (512). The diameter of the drive roller (512) and support rollers (513) is greater than the diameter of the throwing wheel axel (517) which bears the throwing wheel (209). The diametric ratio between the drive roller (512) and throwing wheel axel (517) together with the pulley ratio of the two drive pulleys (506, 508), will scale the rotational speed of the throwing wheel (209) relative to the motor (501). To ensure smooth rotation, upper support rollers (518) in roller housings (519) are actuated by pistons (520) which are affixed to the bearing housings (511, 516) by means of a support beams (521). This enables the upper support rollers (519) to be kept in contact with the throwing wheel axel (517) with a constant force. A hopper assembly (210) injects feedstock into the throwing wheel (209), which accelerates and ejects granular feed stock material at high velocities (522) from the throwing wheel (209), impacting a suitable article (523), creating a deposition (524) upon impingement. Particle scale exaggerated to show detail.

### DRAWING REFERENCE NUMERALS

101. Flow chart of the centrifugal spray additive process.
201. Front disc
202. Back Disc
203. Protrusions
204. Impeller blades
205. Opening
206. Control cage
207. Hopper
208. Feed Opening
209. Throwing Wheel
210. Hopper Assembly
301. Motor
302. Axel
303. Granular feedstock material
304. Article
305. Deposition
401. Motor
402. Axel
403. Bearing
404. Bearing housing
405. Drive pulley
406. Drive belt
407. Drive pulley
408. Axel
409. Bearing
410. Bearing Housing
411. Granular feedstock material
412. Article
413. Deposition
501. Motor
502. Axel
503. Bearing
504. Bearing housing
505. Base plate
506. Drive pulley
507. Drive belt
508. Drive pulley
509. Axel
510. Bearing
511. Bearing housings
512. Drive roller
513. Support roller
514. Axel
515. Bearing
516. Bearing housing
517. Throwing wheel axel
518. Upper support roller
519. Roller housing
520. Pistons
521. Support beam
522. Granular feedstock material
523. Article
524. Deposition

### CONCLUSION

A method and apparatus have been described for producing a deposit from granular feedstock material. This deposition process is kinetic rather than thermal. Compared to traditional kinetic deposition methods such as cold spray, much higher deposition rates can be achieved and at a lower cost with greater energy efficiency. Furthermore, undesirable degradation of properties is avoided by the lower heat input compared to traditional kinetic methods. The lower heat input of the process also results in less distortion and lower levels of undesirable residual stress in the component.

This high-throughput process enables coatings of large surface areas uneconomical by conventional processes. Applications could include coatings on a target surface for greater resistance to wear, impact, high temperature, fatigue, corrosion, and for aesthetic purposes.

Many metallic materials are more readily produced in powder form, and consolidation of these materials can prove challenging and must be done at great cost. Centrifugal spray additive enables deposition of these materials in a cost-effective manner. This can be done to produce raw billet for further processing by conventional processes such as forging or machining. This can also be done for near-net shape additive manufacturing of components, or adding features to existing components. In both of these applications, depositions are removed from the substrate after use. The substrate may be single-use or reusable multiple times. The method for removal may include methods such as removal by application of mechanical forces, chemical attack, and/or thermo-physical means, as is commonplace in additive manufacturing with cold spray.

While the above description contains many specificities, these should not be taken as limitation of scope, but rather exemplification of several possible embodiments. Many other variations are possible. Several obvious variations and applications are listed here.

In addition to coatings and freestanding components, centrifugal spray additive may be used to add features to another finished component. This is distinguished from coatings as these features are non-uniform and thicker. For example, a flange could be deposited onto a pipe produced by conventional means.

A speed of about 300 meters per second or greater is necessary to achieve deposition of the centrifugal spray additive process. However, one of the key advantages of centrifugal spray additive over traditional kinetic deposition methods is the greater ease of scaling particle velocity. Greater impact velocities generally result in better material properties, and it would be an obvious improvement to operate at higher rotational speeds or use a larger diameter throwing wheel to achieve greater impact velocities.

Many improvements have been made to conventional centrifugal wheel blast units used for blasting and shot peening over the years. These improvements include more consistent powder feeding, control of the spray plume shape, and optimization of vane (protrusion) shape. These would be obvious improvements to the centrifugal spray additive process. Other obvious improvements would include removable protrusions from the throwing wheel and existing wear-resistant designs and materials for protrusions from the throwing wheel used in conventional centrifugal blasting to reduce the operating and maintenance cost of the equipment. Finally, an enclosure around the wheel or entire system and dust collection system to prevent egress of granular feedstock material into machinery components or into the surrounding environment would be obvious improvements.

A simple gravity-based hopper system is shown in the drawings for injecting granular feedstock material into the throwing wheel. Other feeding systems which are commonplace in the blasting and powder handling industry may be used. This includes the use fluids to assist feeding, which includes the use of blowers, compressed gases, or liquids. Chutes, tubes, or pipes may be used to couple the hopper and the powder injection point. Additionally, vibration of the hopper may be used to assist gravity-based feeding. Finally, mechanically actuated components such as rotating augers or rotating paddles may be used to control feed rate.

The high rotational speed of the wheel will create vibration, so best practices to reduce vibration, improve high frequency fatigue life, and prevent loosening fasteners are obvious improvements. This includes practices such as the use of dampening materials, vibration resistant fasteners, and fatigue-resistant materials.

Rather than seating the throwing wheel on an axel, a round boss concentric with the throwing wheel may be incorporated into the throwing wheel structure.

To rotate the throwing wheel, any device capable of producing sufficiently high rotational speeds with the required torque may be used. This includes electric motors, spindle motors, pneumatic motors, hydraulic motors, and internal combustion engines. The required speed may be achieved by directly driving the throwing wheel with the rotational device at the required speed, or modifying the speed with a transmission. Speed controlling devices such as a continuous variable transmissions or variable frequency drives may be used to control the rotational speed of the wheel to control particle speed.

Rather than using a drive roller to indirectly couple the rotation of the motor to the throwing wheel, gears may be used.

Rather than injecting powder in the center of the throwing wheel, powder may be injected radially.

Rather than incorporating a single throwing wheel on the axel, multiple throwing wheels may be incorporated onto the same axel. These wheels may have different design characteristics such that feedstock material will be ejected at different velocities.

Granular feedstock material of approximately 50 micrometers to 1000 micrometers in diameter (or equivalent diameter for non-spherical particles) is of greatest interest for this process, but feedstock with smaller or larger diameter may be used for this process.

The centrifugal spray additive process may be used to produce depositions or coatings less than 100 micrometers in thickness. However, given the high feed rates in centrifugal spray additive, these depositions are of less economic interest.

Finally, motor-driven systems may be used to manipulate the centrifugal spray apparatus, target surface, or both simultaneously as is commonplace for similar processes such as cold spray, centrifugal blasting, grit blasting, thermal spray, and directed energy deposition. These motor-driven systems include multi-axis robotic arms, conveyors, lathes, and turntables.

What is claimed is:

1. A method for producing a deposition of material greater than 100 micrometers in thickness on an article, said method comprising:
a) introducing a granular feedstock material into a rotating throwing wheel with a means for imparting kinetic energy from said throwing wheel into said granular feedstock material;
b) accelerating said feedstock material to a velocity greater than 300 meters per second by imparting kinetic energy from said throwing wheel into said granular feedstock material;
c) directing said granular feedstock material after acceleration towards said article, thereby producing said deposition from said granular feedstock material on said article.

2. The method of claim 1, wherein said granular feedstock material comprises at least one of a pure metal, a metallic alloy, or mixtures thereof.

3. The method of claim 2, wherein said granular feedstock material further comprises at least one of a ceramic material, cermet material, or mixtures thereof.

4. The method of claim 2, wherein one or more of the said granular feedstock material constituents is nano-crystalline, amorphous, dispersion strengthened, carbon nanotube reinforced, graphene reinforced, nano-diamond reinforced, or otherwise nano-structured.

5. The method of claim 1, wherein said granular feedstock material comprises a polymer.

6. The method of claim 1, wherein said deposition is removed from said article to produce a free-standing component not attached to said article.

7. The method of claim 1, wherein said deposition is a coating of about uniform thickness on said article.

8. The method of claim 6, wherein the uniformity of said coating is within about plus-or-minus 20 percent of the average coating thickness.

9. The method of claim 1, wherein the average particulate diameter or equivalent particulate diameter of said granular feedstock material is about 50 micrometers to 1000 micrometers.

10. The method of claim 1, wherein said method is carried out in an enclosed, controlled atmosphere comprising at least one of hydrogen, helium, methane, carbon monoxide, carbon dioxide, ammonia, nitrogen, water vapor, oxygen, argon, or mixtures thereof for the purpose of altering the drag characteristics or chemical reactions of said granular feedstock material.

11. The method of claim 1, wherein said method is carried out in a vacuum for the purpose of altering the drag characteristics or chemical reactions of said granular feedstock material.

12. An apparatus for producing a deposition greater than 100 micrometers in thickness on an article, said apparatus comprising:
a) a hopper for injecting a granular feedstock material into a rotating throwing wheel;
b) said throwing wheel comprising one or more protrusions for the purpose of imparting kinetic energy into said granular feedstock material;
c) the geometry of said protrusions, the geometry of said throwing wheel, and the rotational speed of said throwing wheel being sufficient to eject said granular feedstock material at velocities greater than 300 meters per second,
thereby ejecting said granular feedstock material from said throwing wheel towards said article produces said deposition on said article.

13. The apparatus of claim 12, wherein at least one support roller is used to stabilize the rotation of said throwing wheel.

14. The apparatus of claim 13, wherein at least one out of said support rollers is actuated by at least one piston to maintain contact between said support rollers and either said throwing wheel or a throwing wheel axel upon which said throwing wheel is seated.

15. The apparatus of claim 12, wherein said throwing wheel is directly driven by a motor.

16. The apparatus of claim 12, wherein said throwing wheel is driven by a motor with a means for indirectly coupling the rotation from said motor to said throwing wheel.

17. The apparatus of claim 16, wherein said means for indirectly coupling the rotation from said motor to said throwing wheel increases the rotational speed of said throwing wheel relative to said motor.

18. The apparatus of claim 17, wherein said means for indirectly coupling the rotational energy from said motor to said throwing wheel comprises:
a) A drive roller directly or indirectly driven by said motor brought in contact with a throwing wheel axel upon which is seated said throwing wheel;
b) Said drive roller having a diameter greater than that of said throwing wheel axel which increases the rotational speed of said throwing wheel relative to said motor.
